(19) United States
(12) Patent Application Publication
(10) Pub. No.: US 2015/0321544 A1
(43) Pub. Date: Nov. 12, 2015

(54) ELASTIC VEHICLE COVER

(71) Applicant: Craig Costello, West Islip, NY (US)

(72) Inventor: Craig Costello, West Islip, NY (US)

(21) Appl. No.: 14/274,357

(22) Filed: May 9, 2014

(51) Int. Cl. B60J 11/04; B32B 5/02

(52) U.S. Cl. CPC B60J 11/04; B32B 5/02; B32B 2605/00; B32B 2307/71; B32B 2307/7265

(57) ABSTRACT

A vehicle cover designed for a vehicle type including a number of vehicle models. The vehicle cover includes an elastic sheet having an outer edge and a sheet elasticity, and a security band coupled to the outer edge of the elastic sheet to hold the vehicle cover in place over the vehicle. The elastic sheet is formed in a predetermined shape. The sheet elasticity and shape of the elastic sheet are selected such that the elastic sheet is deformable to fit snugly over a vehicle of any of vehicle models of the vehicle type with the outer edge of the elastic sheet adjacent to a bottom portion of the vehicle.

### TECHNICAL FIELD

The present invention is directed generally to covers for various types of vehicles, and, more particularly, to vehicle covers formed from an elastic material allowing a single cover to conform to vehicles of differing shapes.

### BACKGROUND OF THE INVENTION

Car covers have been around almost as long as automobiles have. These car covers serve to protect the users' automobiles from the elements.

As car owners developed into car enthusiasts, simple canvas tarps gave way to custom fitted car covers. Because custom fitted covers are specifically designed for a particular vehicle make and model, they also be simpler to secure on the automobile than a generic tarp or plastic sheet. Additionally, these custom fitted covers may provide better protection, particularly from windblown debris than a tarp. And they may be more aesthetically pleasing to the car enthusiast.

Such custom fitted car covers enjoy significant popularity among car enthusiasts. Although there have been a number of improvements to these custom fitted car covers over the years, the basic concept of specifically designing these covers for a particular vehicle make and model has remained. However, there are drawbacks to producing a custom fitted car cover for a specific vehicle make and model. These drawback may include the required stocking space for retailers, the need for bulk users, such as fleet owners and auto dealers, to obtain new covers when they obtain new vehicles.

Example embodiments of the present invention may provide a number of improvement for car covers, as well as covers for other vehicles, including improved versatility and additional utility. These and other advantages of the present invention may be understood by those skilled in the art from the following detailed description.

### SUMMARY OF THE INVENTION

An example embodiment of the present invention is a vehicle cover designed for a vehicle type including a number of vehicle models. The vehicle cover includes an elastic sheet having an outer edge and a sheet elasticity, and a security band coupled to the outer edge of the elastic sheet to hold the vehicle cover in place over the vehicle. The elastic sheet is formed in a predetermined shape. The sheet elasticity and shape of the elastic sheet are selected such that the elastic sheet is deformable to fit snugly over a vehicle of any of vehicle models of the vehicle type with the outer edge of the elastic sheet adjacent to a bottom portion of the vehicle.

It is to be understood that both the foregoing general description and the following detailed description are illustrative, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a side plan drawing of an example elastic vehicle cover according to the present invention;

FIG. 2 is a top plan drawing of another example elastic vehicle cover according to the present invention;

FIG. 3A is a side plan drawing of another example elastic vehicle cover according to the present invention;

FIG. 3B is a perspective drawing of a further example elastic vehicle cover according to the present invention;

FIG. 4A is a bottom plan drawing of an example elastic vehicle cover according to the present invention illustrating an example security band;

FIG. 4B is a bottom plan drawing of an example elastic vehicle cover according to the present invention illustrating another example security band;

FIG. 4C is a bottom plan drawing of an example elastic vehicle cover according to the present invention illustrating a further example security band;

FIG. 5 is a perspective drawing of an example three panel elastic vehicle cover according to the present invention;

FIG. 6 is an exploded schematic drawing of the example three panel elastic vehicle cover of FIG. 5 illustrating the shape of the example panels prior to their assembly;

FIG. 7A is a schematic drawing of a side panel pattern of another example three panel elastic vehicle cover according to the present invention;

FIG. 7B is a schematic drawing of a side panel pattern of another example three panel elastic vehicle cover according to the present invention;

FIG. 7C is a schematic drawing of a side panel pattern of a further example three panel elastic vehicle cover according to the present invention;

FIG. 7D is a schematic drawing of a side panel pattern of an additional example three panel elastic vehicle cover according to the present invention; and

FIG. 8 is side cut-away drawing of an example multi-ply material that may be included in the elastic sheet of example elastic vehicle covers according to the present invention.

### DETAILED DESCRIPTION OF THE INVENTION

Example embodiments of the present invention include various elastic vehicle covers. These example elastic vehicle covers are designed to desirably stretch and, thus, snugly fit any of a number of different vehicle makes and models within a vehicle type. Such vehicle types, may include: sedans; coupes; hatchbacks; minivans; sports cars; vans; sports utility vehicles (SUVs); pickup trucks; motorcycles; jet skis; snowmobiles; all-terrain vehicles (ATVs); scooters; riding lawnmowers; recreational vehicles (RVs); boats; etc. This list is intended to be illustrative, and not limiting.

Example elastic vehicle covers according to the present invention may simplify stocking for retailers by allowing the retailer to stock covers for a large variety of makes and models of vehicles using a relatively small number of sizes of elastic vehicle covers, as opposed to a much larger number of custom fitted vehicle covers for each make and model. This simplified stocking may reduce the necessary stock and hand (and associated stocking costs), as well as reducing the shelf space devoted to vehicle covers. Alternatively, the reduced number of sizes may allow for greater varieties of styles, designs, etc. to be stocked.

For dealerships or fleet owners, such as rental car companies, example elastic vehicle covers according to the present invention may also prove desirable. As the dealership's vehicle stock or a rental company's fleet of vehicles changes, they may be able to desirably reuse their elastic vehicle covers for their new vehicles.

Currently available custom fitted vehicle covers tend to be sturdy and bulky, designed to provide significant protection against the entire gamut of environmental hazards. The potential economies of scale that example elastic vehicle covers according to the present invention may allow may also desirably allow for production of inexpensive, lightweight elastic vehicle covers that may provide light to moderate environmental protection, in addition to more substantial vehicle covers that provide protection against more extreme conditions. Example lightweight elastic vehicle covers may desirably be light, easy to put on the vehicle, and easy to store. Additionally, example elastic vehicle covers may serve other purposes, such as aesthetics, entertainment, or use for advertising, all of which may be assisted by the economies of scale that may be afforded by more standardized sizing.

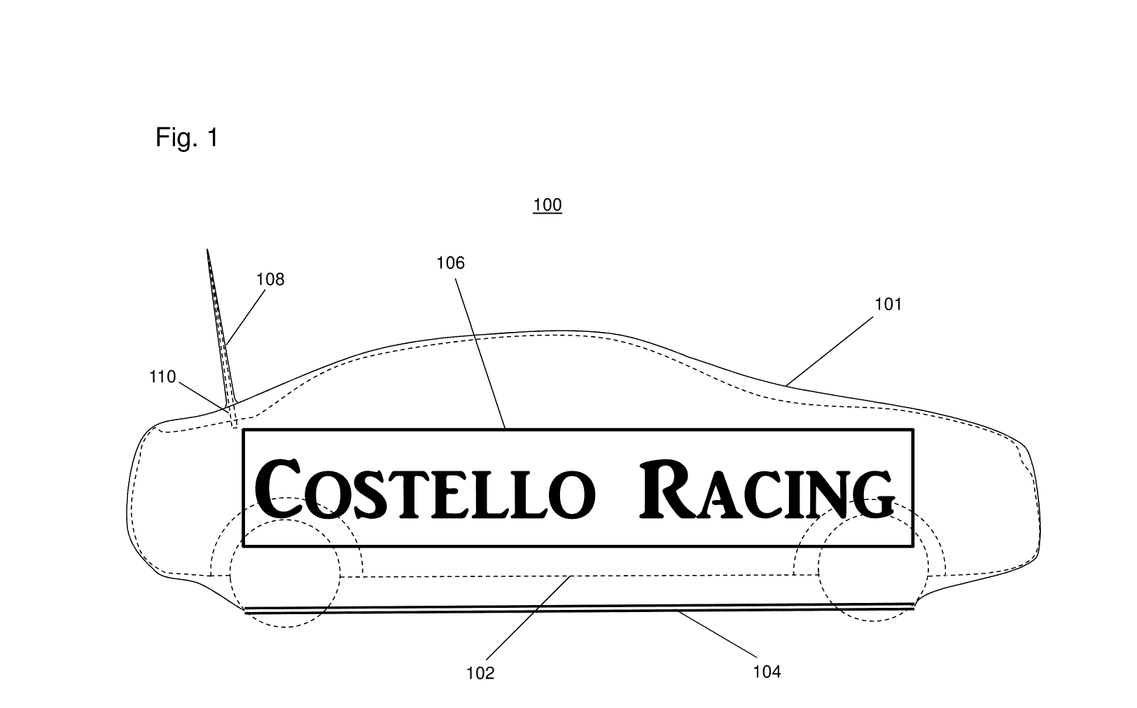

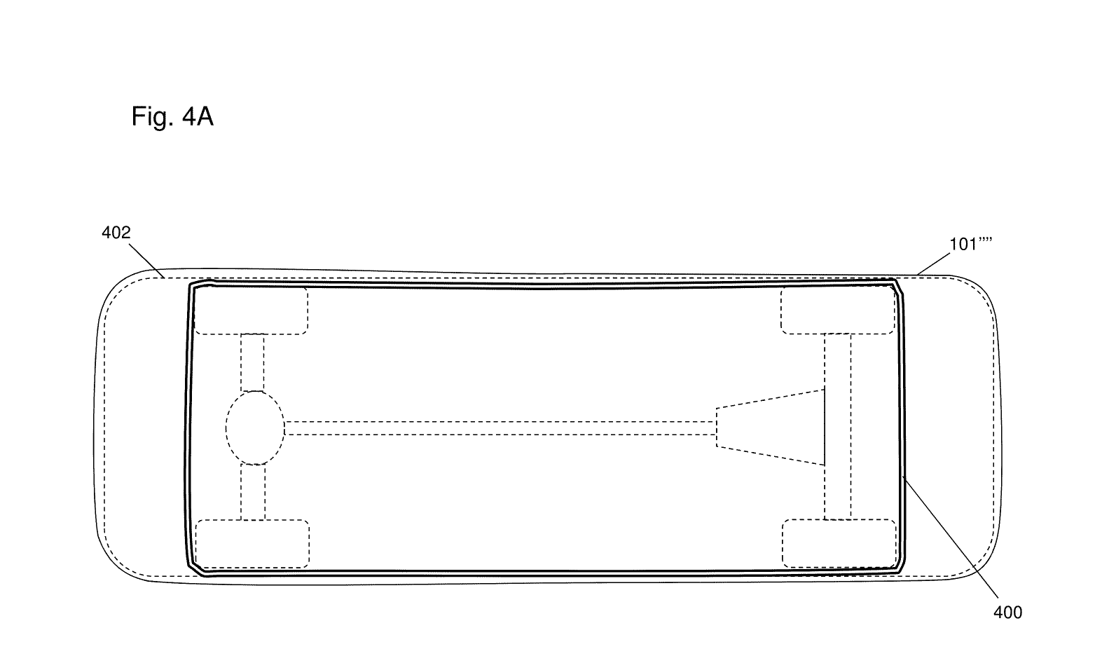

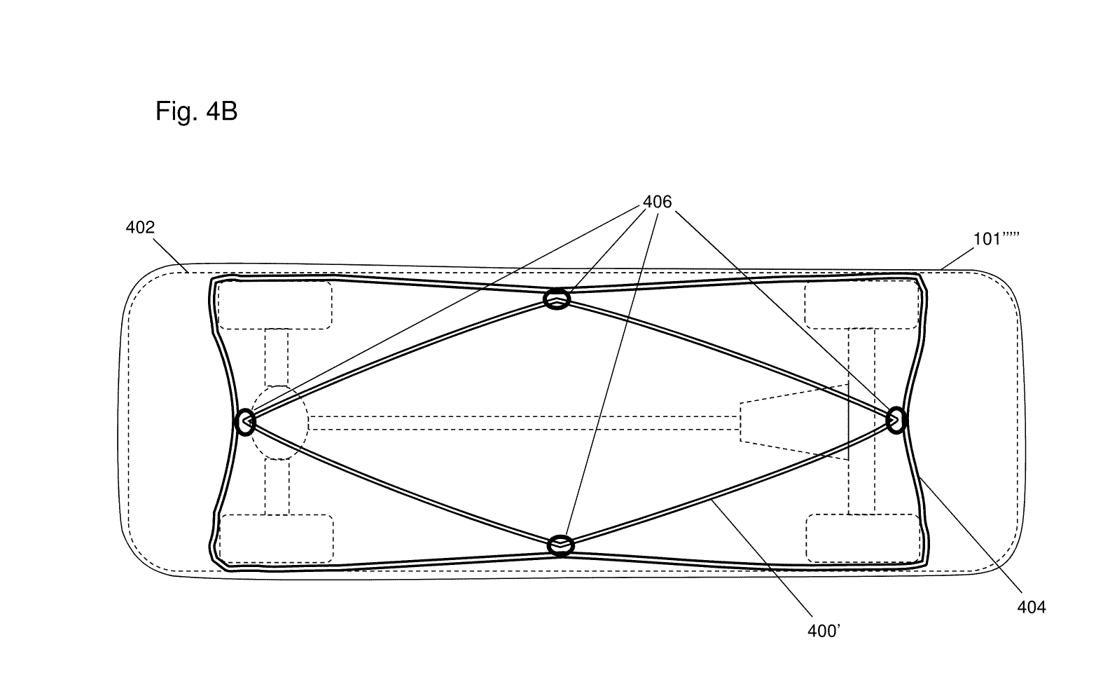

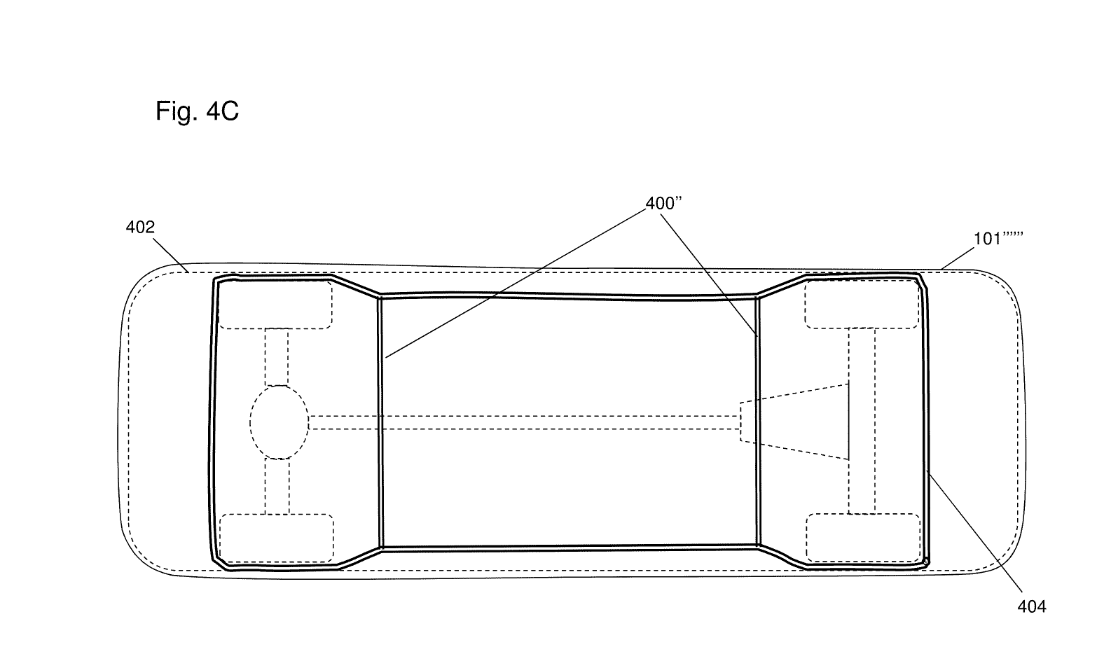

FIG. 1 illustrates example vehicle cover 100 according to the present invention. In this example, elastic sheet 101 is shown stretched to fit over sedan 102. Elastic sheet 101 is secured in place over sedan 102 with security band 104, which is coupled to the outer edge of elastic sheet 101. Various example security bands and ways of coupling these security band to the elastic sheet are discussed hereinbelow with reference to FIGS. 4A-C.

Elastic sheet 101 is formed in a predetermined shape (depending of the vehicle type for which it is intended) of an elastic material that has a desired sheet elasticity. The sheet elasticity and the shape of the elastic sheet are selected such that the elastic sheet may be deformed to fit snugly over a vehicle of any make or model within the vehicle type, with the outer edge of the elastic sheet adjacent to a bottom portion of the vehicle so that security band may hold it in place. The elastic material from which the elastic sheet is formed may include: a knitted fabric; a woven material formed of elastic fibers; an elastic polymer sheet; or a rubber sheet, among other materials. Desirably, this elastic material has a maximum elastic strain greater than or equal to a predetermined maximum strain value.

Knitted materials may be particularly desirable as the knitting process may result in fabric that is both strong and significantly more elastic than a woven fabric of the same fibers. If a knitted fabric is used, the knitting pattern of the knitted fabric may be selected such that the knitted fabric has a maximum elastic strain greater than or equal to a predetermined maximum strain value. Typical textile fibers such as wool, cotton, polyester, nylon, silk, and linen may be used. Spandex or spandex blend fibers may be desirable due to the elastic properties of spandex.

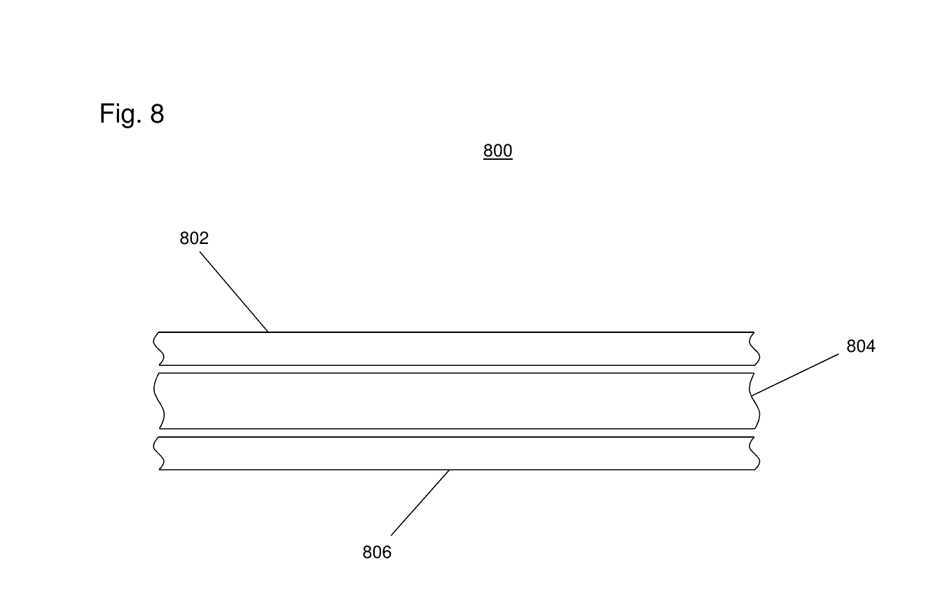

It may be desirable for the elastic material of the elastic sheet to be at least one of the following properties: substantially waterproof; water resistance; substantially dustproof; dust resistance; substantially blocking to ultraviolet (UV) radiation; substantially blocking to visible radiation; and/or substantially blocking to infrared (IR) radiation. To provide one or more of these properties it may be desirable for the elastic sheet to include at least one of: a knitted fabric including hydrophobic fibers; a knitted fabric treated with a hydrophobic coating; a woven material formed of elastic, hydrophobic fibers; a woven material formed of elastic fibers and treated with a hydrophobic coating; a substantially impermeable, elastic polymer sheet; or a rubber sheet. Expanded polytetrafluoroethylene (ePTFE) may also a desirable material for use in elastic sheet 101, as an elastic polymer sheet. The use of ePTFE may be particularly desirable in a multi-ply elastic sheet design, discussed in detail hereinbelow with reference to FIG. 8.

It is noted that in one example embodiment the elastic sheet of the example vehicle cover may include an elastic material having a design printed on at least a portion of the elastic material. The design printed on the elastic material may include any of a number of different designs including, but not limited to: an advertisement; a geometric pattern; a photo print; text; or a design selected to replicate a specific vehicle. As illustrated in FIG. 1, elastic sheet 101 includes printed text advertisement 106. Such use of the available space on an example vehicle cover according to the present invention may allow businesses, or individuals with a quick inexpensive means of advertising, which can be easily changed (by changing the vehicle cover) or relocated (by moving the vehicle). It is contemplated that example vehicle covers within the scope of the present disclosure may be designed to have substantially transparent sections over the windows, allowing advertisements printed on the elastic materials of such vehicle covers to be used as mobile advertisements. Such advertising uses may be particularly desirable in locations where ‘fixed’ advertising signs and billboards are not allowed.

Additionally, it is contemplated that example embodiments of the present invention may include vehicle covers with coupling means, such as hook and loop couplers, to attach advertising signs to the example vehicle cover. Alternatively, three dimensional features, such as fins, or rabbit ears could be affixed the exterior of an example vehicle cover according to the present invention by such means.

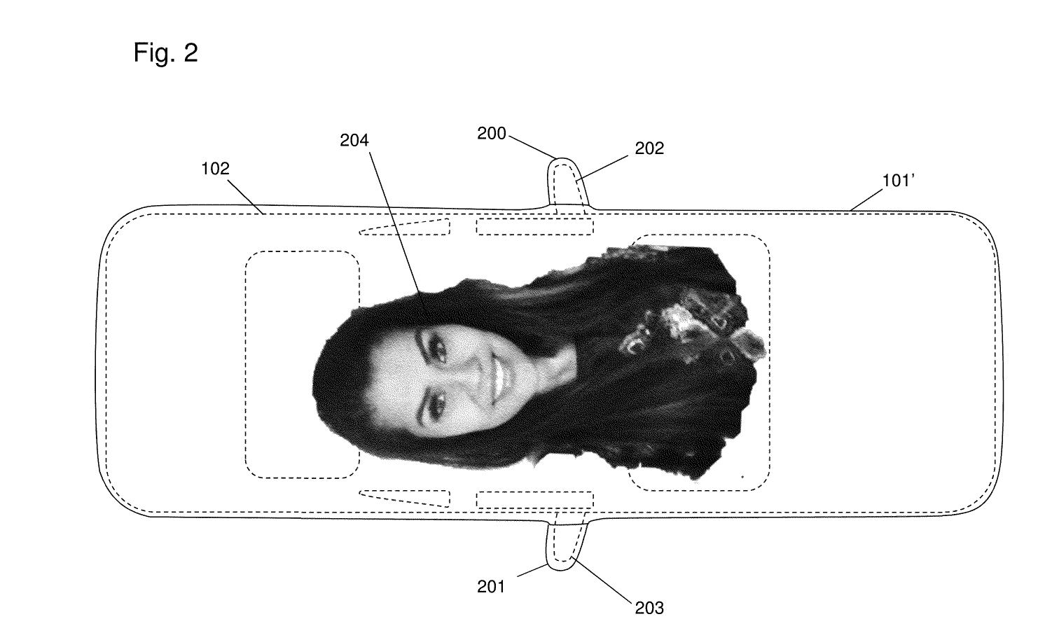

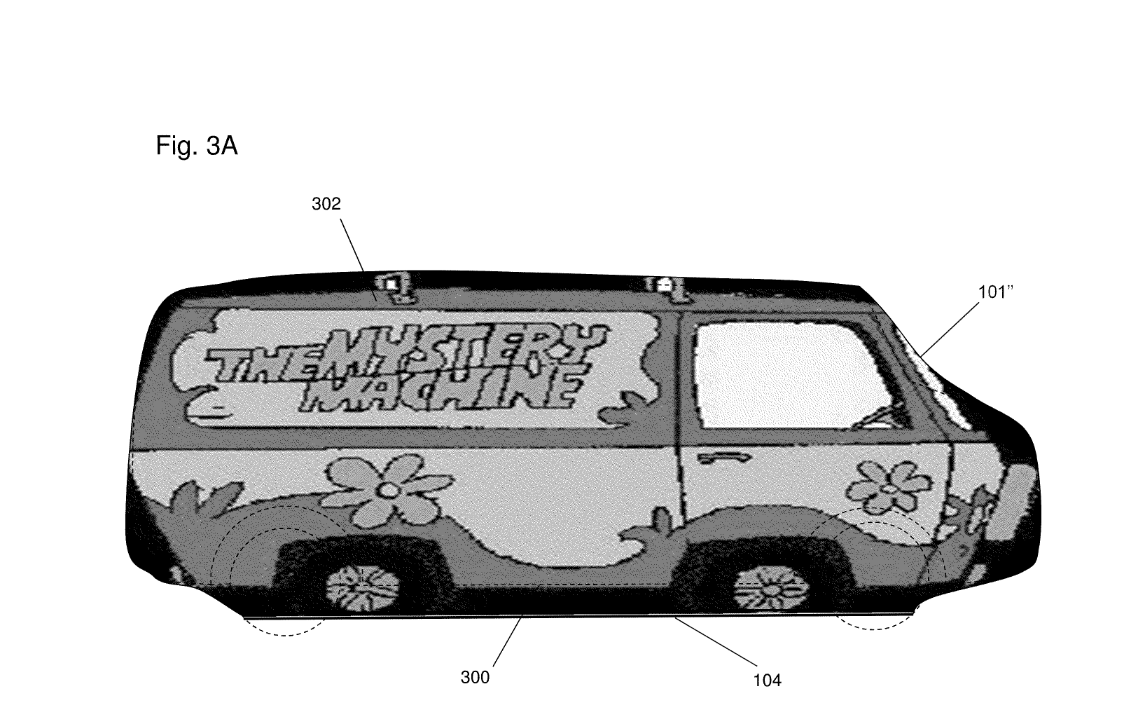

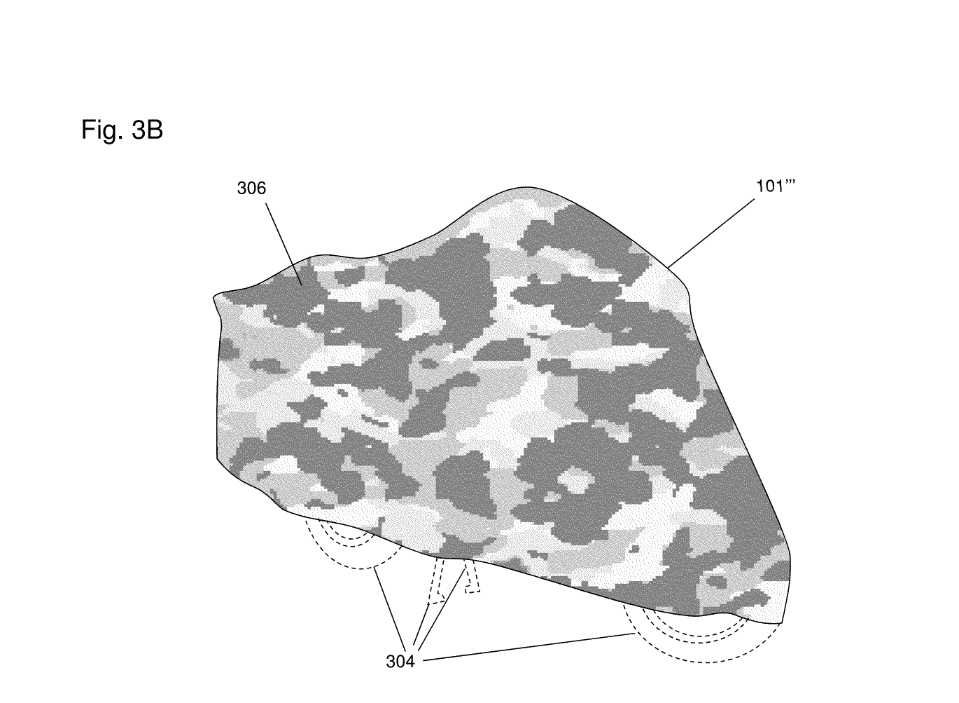

FIG. 2 illustrates another example vehicle cover in which photo print 204 has been printed on example elastic sheet 101′. In FIG. 3A, sample design 302 printed on elastic sheet 101″ may allow van 300 to appear as The Mystery Machine from Scooby Doo. And FIG. 3B illustrates an example elastic motorcycle cover with camouflage design 306 printed on elastic sheet 101′″ stretched over motorcycle 304.

Returning to FIG. 1, example vehicle cover 100 illustrates another example embodiment of the present invention. Elastic sheet 101 includes an opening shaped and located to allow antenna 110 to extend through it. Pouch 108 is coupled to the edge of this opening to cover antenna 110. It is contemplated that instead of a pouch sized to cover one of antenna 110, the opening in elastic sheet 101 could be coupled to a grommet to fit over antenna 110.

FIG. 2 illustrates an alternative embodiment in which elastic cover 101′ has two openings coupled to pouches 200 and 201 shaped and located to accommodate, respectively, side view mirrors 202 and 203 of sedan 102. It is noted that other protrusions that extend from the vehicle body, such as a trailer hitch or handle bars, may be similarly accommodated.

FIGS. 4A-C are bottom plan views of automobile 402 covered by example vehicle covers according to the present invention to illustrate several alternative example security band configurations. The choice to use automobile 402 in each of these figures is to simplify the drawing and highlight the alternative embodiments, and is not intended as limiting.

In FIG. 4A, security band 400 is shown coupled to elastic sheet 101″″ all along its outer edge. Security band 400 in this embodiment may be a closed elastic band coupled along the outer edge of elastic sheet 101″″ by a means such as: stitching; adhesive bonding; solvent welding; or thermal welding, laced through the outer edge portion of elastic sheet 101″″. Alternatively, security band 400 may include a series of elastic straps, each fixedly coupling a pair of coupling points on the outer edge of elastic sheet 101″″, e.g. four elastic straps located in the four corners. In these example embodiments, the elastic vehicle cover may be put on the vehicle by pulling it over the vehicle like a fitted sheet.

In another alternative embodiment, security band 400 in FIG. 4A may be a substantially inelastic drawstring laced through the outer edge portion of elastic sheet 101″″. In this example embodiment, the elastic vehicle cover may be put on the vehicle by pulling it over the vehicle, then pulling the substantially inelastic drawstring to snug the cover down over the vehicle. The ends of the substantially inelastic drawstring may be coupled by various means, such as tying, buckling, or otherwise connecting the ends. In one example embodiment, the substantially inelastic drawstring may be a wire cable (or similar) and couple the ends may include locking the ends together with a padlock. This example elastic vehicle cover may provide security against theft in addition to environment protection.

FIG. 4B illustrates an a further example embodiment in which one or more elastic (or inelastic) straps 400′ are removably coupled between coupling points 406 on the outer edge 404 of elastic sheet 101′″″. Straps 400′ may form a closed band that passes through all four coupling points 406, or they may be four separate bands that are coupled to coupling points 406 at each end by means such as hooking or tying. It is noted that, although coupling points 406 are shown as loops coupled to the outer edge 404 of elastic sheet 101′″″ in FIG. 4B, one skilled in the art may understand that these coupling points may also be reinforced opening in elastic sheet 101′″″. Additionally, it is noted that four coupling points 406 were selected for illustrative purpose only, and is not intended as limiting.

In the example embodiments of FIG. 4B, the elastic vehicle cover may be put on the vehicle by pulling it over the vehicle, then coupling straps 400′ to coupling points 406 to snug the cover down over the vehicle.

FIG. 4C illustrates an additional example embodiment in which one or more elastic (or inelastic) straps 400″ are fixedly coupled at one end and removably coupled at the other end between points on the outer edge 404 of elastic sheet 101″″″. As with straps 400′ in the example embodiments of FIG. 4B, straps 400″ may be removably coupled to couple point on the outer edge 404 of elastic sheet 101″″″ by means such as hooking or tying. It is noted that selection to show two straps 400″ was for illustrative purpose only, and is not intended as limiting.

In the example embodiments of FIG. 4C, the elastic vehicle cover may be put on the vehicle by pulling it over the vehicle, then coupling straps 400″ to their removable coupling points to snug the cover down over the vehicle.

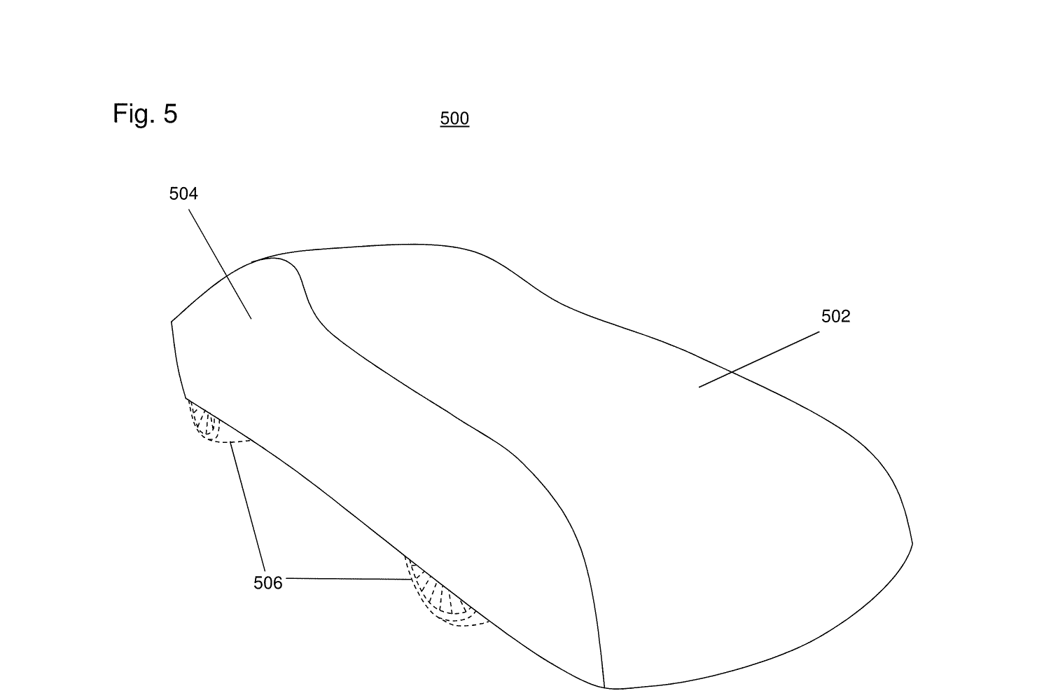

FIG. 5 is a perspective drawing illustrating alternative example three panel elastic vehicle cover 500 according to the present invention, which is covering coupe 506. In this perspective drawing, top panel 502 and one side panel 504 are shown. (The other side panel is behind the car.)

As illustrated in FIG. 6 (which is an exploded view of example three panel elastic vehicle cover 500), this alternative example embodiment may provide a simple approach to producing standardized elastic vehicle covers for a variety of vehicle types. Three panel elastic vehicle cover 500 includes rectangular top panel 502 and two mirror image side panels 504 that are cut into a shape that is substantially straight on the bottom and curved like an archetypical vehicle model of the vehicle type on the top; for example, top edges 604 of side panels 504 of example three panel elastic vehicle cover 500 are curved to approximate an archetypical coupe silhouette and bottom edges 608 are substantially straight. (Similarly, the top edges of the side panels for expel example three panel elastic riding lawnmower cover are curved to approximate an archetypical riding lawnmower silhouette.)

FIG. 6 also illustrates (using arrows 600 how the three panel fit together in this example embodiment. Side edges 602 of top panel 502 are sized to be as long as the curved top edges 604 of side panels 504, and are coupled to top edges 604 of side panels 504 to form the elastic sheet of example three panel elastic vehicle cover 500. Front and back end edges 604 of top panel 502 and bottom edges 608 of side panels 504 form the outer edge of the elastic sheet.

Side edges 602 of top panel 502 may be coupled to top edges 604 of side panels 504 using at least one of: stitching; adhesive bonding; solvent welding; or thermal welding, depending on the materials of top panel 502 and side panels 504, as well as the types of environmental protection to be provided to the vehicle.

In addition to the simplicity of construction, this example embodiment allows for the use of different materials for top panel 502 and side panels 504. For example it may desirable for some applications, if top panel 502 is substantially inelastic, while side panels 504 are sufficiently elastic to provide the desired maximum elastic strain, or vice versa. Or it may be desirable for the different panels to have different maximum elastic strains.

Additionally, multi-panel construction may allow for one or more of the panels of the elastic sheet to include an elastic material with a design printed on at least a portion of it prior to coupling the panels together. Because this example construction approach allows a vehicle cover with a three dimensional elastic sheet to be formed from a number of flat panels, printing a design on one or more of the panels prior to construction may be significant easier than printing on the completed elastic sheet.

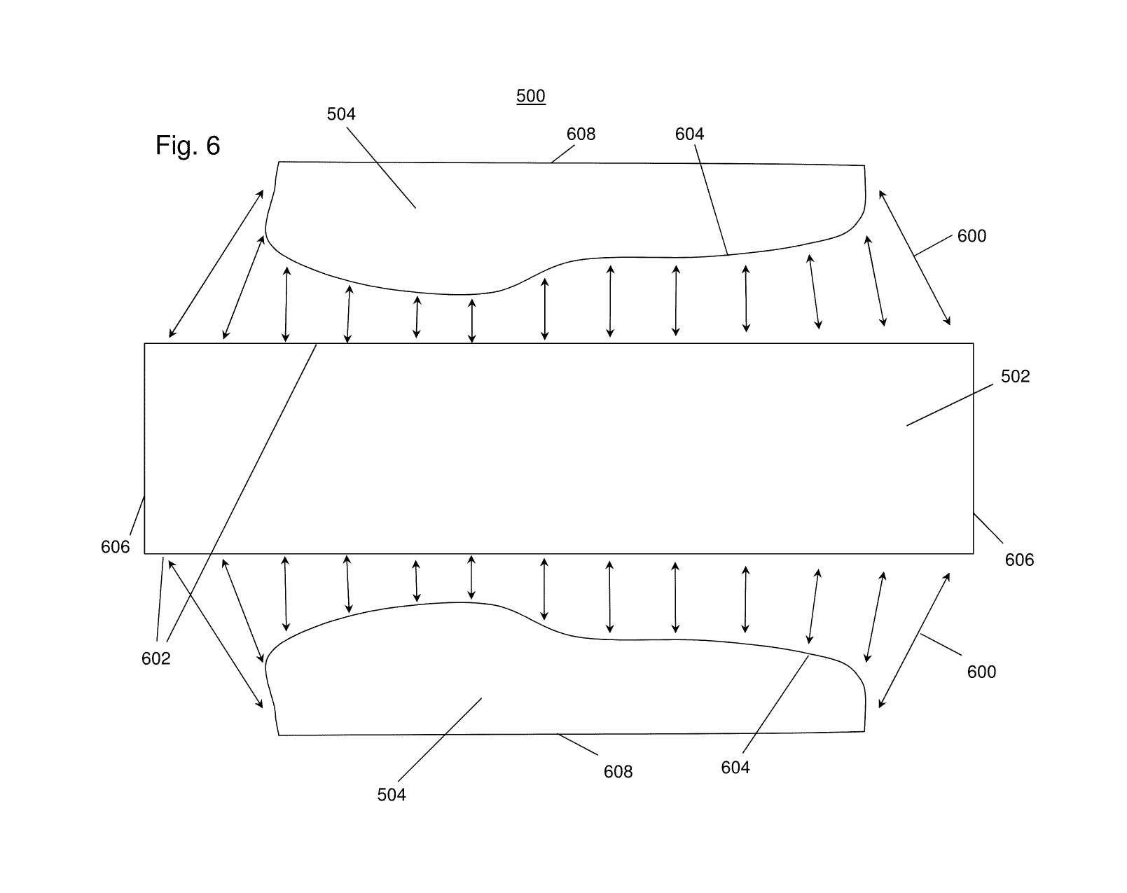

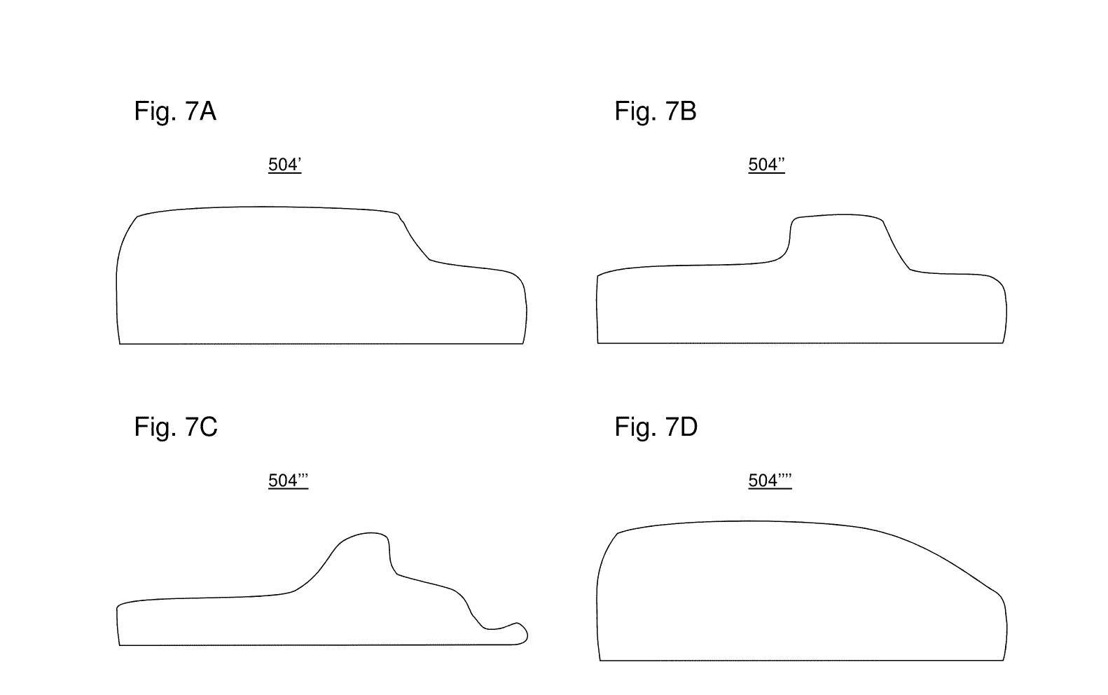

FIGS. 7A-D illustrate 4 alternative example side panels that may be used with the example three panel elastic vehicle cover embodiments of FIGS. 5 and 6. FIG. 7A shows SUV side panel 504′ in which the top edge of the side panel is curved to approximate an archetypical SUV silhouette. FIG. 7B shows pickup truck side panel 504″ in which the top edge of the side panel is curved to approximate an archetypical pickup truck silhouette. FIG. 7C shows snowmobile side panel 504′″ in which the top edge of the side panel is curved to approximate an archetypical snowmobile silhouette. And FIG. 7D shows minivan side panel 504″″ in which the top edge of the side panel is curved to approximate an archetypical minivan silhouette. It is noted that these four side panels were chosen for illustrative purpose only and are not intended as limiting.

FIG. 8 shows example multi-ply material 800 that may be used to form the elastic sheet in any of the example embodiments described above with reference to FIGS. 1, 2, 3A, 3B, 4A-C, 5, 6, and/or 7A-D. Example multi-ply material 800 includes outer ply 802, middle ply 804, and inner ply 806. The material of outer play 802 may desirably be selected for durability, and may also be selected for its ability to be printed on easily. The material of middle ply 804 may be selected to provide environment protection to the vehicle. For example the middle ply may desirably be one or more of: substantially waterproof; water resistant; substantially dustproof; dust resistant; substantially blocking to ultraviolet (UV) radiation; substantially blocking to visible radiation; or substantially blocking to infrared (IR) radiation. Inner play 806 may desirably be a fabric ply selected to substantially protect the surface of the vehicle type during use of the example elastic vehicle cover.

It is noted that although FIG. 8 illustrated exactly three plies, this is illustrative and not intended to be limiting. For example, more than one middle ply may be used to obtain the desire range of properties. Alternatively, middle ply 804 may be omitted and outer ply 802 and/or inner ply 806 may supply the desired level of environmental protection.

Although illustrated and described herein with reference to certain specific embodiments, the present invention is nevertheless not intended to be limited to the details shown. Rather, various modifications may be made in the details within the scope and range of equivalents of the claims and without departing from the invention. In particular, it is noted that while the disclosures provided herein focus on example elastic vehicle covers, similar elastic covers for objects such as dumpsters, buildings, trees, boulders, etc. are contemplated.

What is claimed:

1. A vehicle cover designed for a vehicle type including a plurality of vehicle models, the vehicle cover comprising:
an elastic sheet having an outer edge and a sheet elasticity, the elastic sheet being formed in a predetermined shape, the sheet elasticity and predetermined shape of the elastic sheet being selected such that the elastic sheet is deformable to fit snugly over a vehicle of each of the plurality of vehicle models of the vehicle type with the outer edge of the elastic sheet adjacent to a bottom portion of the vehicle; and
a security band coupled to the outer edge of the elastic sheet to hold the vehicle cover in place over the vehicle.

2. The vehicle cover of claim 1, wherein the elastic sheet includes at least one of:
a knitted fabric;
a woven material formed of elastic fibers;
an elastic polymer sheet; or
a rubber sheet.

3. The vehicle cover of claim 1, wherein the elastic sheet is formed of an elastic material having a predetermined maximum elastic strain.

4. The vehicle cover of claim 3, wherein the elastic material includes a knitted fabric, a knitting pattern of the knitted fabric selected such that the knitted fabric has the predetermined maximum elastic strain.

5. The vehicle cover of claim 1, wherein the elastic material is at least one of: substantially waterproof; water resistant; substantially dustproof; dust resistant; substantially blocking to ultraviolet (UV) radiation; substantially blocking to visible radiation; or substantially blocking to infrared (IR) radiation.

6. The vehicle cover of claim 5, wherein the elastic sheet includes at least one of:
a knitted fabric including hydrophobic fibers;
a knitted fabric treated with a hydrophobic coating;
a woven material formed of elastic, hydrophobic fibers;
a woven material formed of elastic fibers and treated with a hydrophobic coating;
a substantially impermeable, elastic polymer sheet; or
a rubber sheet.

7. The vehicle cover of claim 1, wherein the elastic sheet includes an elastic material having a design printed on at least a portion of the elastic material.

8. The vehicle cover of claim 7, wherein the design printed on the elastic material includes at least one of: an advertisement; a geometric pattern; a photo print; text; or a design selected to replicate a specific vehicle.

9. The vehicle cover of claim 1, wherein:
the outer edge of the elastic sheet includes a first portion, a second portion, a third portion and a fourth portion; and
the elastic sheet is formed of:
a first side panel having a bottom edge and a top edge, the bottom edge forming the first portion of the outer edge of the elastic sheet;
a top panel including a front edge, a first side edge, a second side edge, and a back edge, the front edge forming the second portion of the outer edge of the elastic sheet, the back edge forming the third portion of the outer edge of the elastic sheet, and the first side edge being coupled to the top edge of the first side panel; and
a second side panel having a bottom edge and a top edge, the bottom edge forming the fourth portion of the outer edge of the elastic sheet, and the top edge being coupled to the second side edge of the top panel.

10. The vehicle cover of claim 9, wherein:
the first side edge of the top panel of the elastic sheet is coupled to the top edge of the first side panel of the elastic sheet using at least one of: stitching; adhesive bonding; solvent welding; or thermal welding; and
the second side edge of the top panel of the elastic sheet is coupled to the top edge of the second side panel of the elastic sheet using at least one of: stitching; adhesive bonding; solvent welding; or thermal welding.

11. The vehicle cover of claim 9, wherein at least one of:
the top panel of the elastic sheet is formed of an elastic material having a predetermined maximum elastic strain; or
the first side panel and the second side panel of the elastic sheet are formed of an elastic material having a predetermined maximum elastic strain.

12. The vehicle cover of claim 9, wherein:
the top panel of the elastic sheet is substantially rectangular shaped;
the bottom edge of the first side panel and the bottom edge of the second side panel of the elastic sheet are substantially straight;
the vehicle type is one of;
a sedan, and the top edge of the first side panel and the top edge of the second side panel of the elastic sheet are curved to approximate an archetypical sedan silhouette;
a coupe, and the top edge of the first side panel and the top edge of the second side panel of the elastic sheet are curved to approximate an archetypical coupe silhouette;
a minivan, and the top edge of the first side panel and the top edge of the second side panel of the elastic sheet are curved to approximate an archetypical minivan silhouette;
a sports car, and the top edge of the first side panel and the top edge of the second side panel of the elastic sheet are curved to approximate an archetypical sports car silhouette;
a van, and the top edge of the first side panel and the top edge of the second side panel of the elastic sheet are curved to approximate an archetypical van silhouette;
a sports utility vehicle (SUV), and the top edge of the first side panel and the top edge of the second side panel of the elastic sheet are curved to approximate an archetypical SUV silhouette;
a pickup truck, and the top edge of the first side panel and the top edge of the second side panel of the elastic sheet are curved to approximate an archetypical pickup truck silhouette;
a motorcycle, and the top edge of the first side panel and the top edge of the second side panel of the elastic sheet are curved to approximate an archetypical motorcycle silhouette;
a jet ski, and the top edge of the first side panel and the top edge of the second side panel of the elastic sheet are curved to approximate an archetypical jet ski silhouette;
a hatchback, and the top edge of the first side panel and the top edge of the second side panel of the elastic sheet are curved to approximate an archetypical hatchback silhouette;
a snowmobile, and the top edge of the first side panel and the top edge of the second side panel of the elastic sheet are curved to approximate an archetypical snowmobile silhouette;
an all-terrain vehicle (ATV), and the top edge of the first side panel and the top edge of the second side panel of the elastic sheet are curved to approximate an archetypical ATV silhouette;
a scooter, and the top edge of the first side panel and the top edge of the second side panel of the elastic sheet are curved to approximate an archetypical scooter silhouette;
a boat, and the top edge of the first side panel and the top edge of the second side panel of the elastic sheet are curved to approximate an archetypical boat silhouette;
a riding lawnmower, and the top edge of the first side panel and the top edge of the second side panel of the elastic sheet are curved to approximate an archetypical riding lawnmower silhouette; or
a recreational vehicle (RV), and the top edge of the first side panel and the top edge of the second side panel of the elastic sheet are curved to approximate an archetypical RV silhouette.

13. The vehicle cover of claim 9, wherein at least one of the top panel, the first side panel, or the second side panel of the elastic sheet includes an elastic material having a design printed on at least a portion of the elastic material prior to coupling of the top panel to the first side panel and the second side panel.

14. The vehicle cover of claim 1, wherein the elastic sheet includes at least one opening, each opening shaped and located to accommodate one of: an antenna; a side view mirror, or a trailer hitch.

15. The vehicle cover of claim 14, wherein one of the at least one opening in the elastic sheet is coupled to one of:
a grommet; or
a pouch sized to cover one of the antenna, the side view mirror or the trailer hitch that the opening is shaped and located to accommodate.

16. The vehicle cover of claim 1, wherein the elastic sheet is formed of a multi-ply material.

17. The vehicle cover of claim 16, wherein the multi-ply material of the elastic sheet includes:
a fabric ply located on the side of the elastic sheet facing the vehicle type during use, the fabric ply selected to substantially protect a surface of the vehicle type during use; and
an outer ply.

18. The vehicle cover of claim 17, wherein the outer ply of the multi-ply material of the elastic sheet includes a design printed on at least a portion of the outer ply.

19. The vehicle cover of claim 17, wherein:
the multi-ply material of the elastic sheet further includes a third ply disposed between the fabric ply and the outer ply; and
the third ply is at least one of: substantially waterproof; water resistant; substantially dustproof; dust resistant; substantially blocking to ultraviolet (UV) radiation; substantially blocking to visible radiation; or substantially blocking to infrared (IR) radiation.

20. The vehicle cover of claim 17, wherein the outer ply of the multi-ply material of the elastic sheet is at least one of: substantially waterproof; water resistant; substantially dustproof; dust resistant; substantially blocking to ultraviolet (UV) radiation; substantially blocking to visible radiation; or substantially blocking to infrared (IR) radiation.

21. The vehicle cover of claim 1, wherein the security band, includes at least one of:
a closed elastic band coupled along the outer edge of the elastic sheet;
a substantially inelastic drawstring coupled along the outer edge of the elastic sheet;
one or more elastic straps, each elastic strap fixedly coupled between a pair of coupling points on the outer edge of the elastic sheet;
one or more elastic straps, each elastic strap removably coupled between a pair of coupling points on the outer edge of the elastic sheet; or
one or more substantially inelastic straps, each substantially inelastic strap removably coupled between a pair of coupling points on the outer edge of the elastic sheet.
